(19) United States
(12) Patent Application Publication
(10) Pub. No.: US 2020/0146327 A1
(43) Pub. Date: May 14, 2020

(54) DIETETIC PREPARATION AND DRUG FOR GLUCOSE SUPPLY AND DEMENTIA PREVENTION

(71) Applicant: BM Health GmbH, Wien (AT)

(72) Inventor: Christian R. Noe, Wien (AT)

(73) Assignee: BM Health GmbH, Wien (AT)

(21) Appl. No.: 16/618,132

(22) PCT Filed: May 29, 2018
(86) PCT No.: PCT/EP2018/064008

§ 371 Date: Nov. 28, 2019

(30) Foreign Application Priority Data
May 29, 2017 (AT) A224/2017

(51) Int. Cl. A23L 33/26; A23L 33/15; A23L 33/175; A23L 33/12; A23L 33/105; A23L 27/00; A23L 27/30

(52) U.S. Cl. CPC A23L 33/26; A23L 33/15; A23L 33/175; A23L 27/33; A23L 33/105; A23L 27/88; A23L 33/12

(57) ABSTRACT

A dietetic preparation for preventing or alleviating a glucose deficiency in the brain of humans or mammals, wherein the preparation contains glucose and at least one glucose-free sweetener, wherein the mixture of glucose and glucose-free sweetener has a sweetening power of 1.5 to 3.0, in particular 2.0.

### CROSS-REFERENCE TO RELATED APPLICATION(S)

This application is the National Stage of International Patent Application No. PCT/EP2018/064008 filed on May 29, 2018, which claims priority from Austrian Patent Application No. A224/2017 filed on May 29, 2017, both of which are herein incorporated by reference herein in their entireties.

### BACKGROUND

Glucose, also known as grape sugar or dextrose, is the central molecule of the human energy metabolism. About 200 g glucose per day is needed for the basal metabolic rate of the brain alone. This corresponds to about 25% to 50% of the total (mobilized) glucose available in the organism. This makes the brain by far the largest consumer of glucose in the body. Therefore, the safe supply of glucose to this particular organ is of special importance. A sufficient availability of glucose in the brain at all times is an essential prerequisite for the survival of higher animal life.

In principle, glucose does not spread into the body cells through diffusion, but is introduced molecule by molecule into the individual cells by means of active transport. The insulin system regulates the transport of glucose across the endothelial membranes of blood vessels depending on the local demand by regulating the presentation of glucose transporters in the peripheral body cells.

Given the importance of the brain—the central control organ—for survival, it is not surprising that the brain is strictly separated from the rest of the physiological system. This separation is ensured by the blood-brain barrier. This barrier means nothing other than that the endothelium of the blood vessels in the brain is particularly dense, which largely prevents an uncontrolled diffusion of substances into the brain. The transport of substances into and out of the brain takes place actively with the help of transporters. The efficient function of the glucose transporters at the blood-brain barrier is therefore of paramount importance for survival. The transport of glucose into the brain, which constantly has a high glucose demand, is therefore independent of the insulin system.

Diabetes mellitus type II, which mostly occurs at an advanced age but can also occur at a much younger age as a result of metabolic syndrome, is associated with permanently increased glucose levels in the bloodstream and a reduced sensitivity of the cells to the hormone insulin. Increased chemical side reactions of glucose, which is present in the blood in increased concentrations, are causal factors in further pathophysiological events. Insulin resistance manifests itself in the common presence of elevated blood sugar levels, elevated insulin levels and a reduced uptake of glucose into the target cells (especially liver, muscle and brain cells). The connection between insulin resistance and elevated blood sugar levels has led to the accepted doctrine that under such conditions glucose is a product to be avoided as far as possible. The extensive field of diabetic dietetics has developed under this aspect. A multitude of sweeteners and sugar substitutes, all of which do not contain glucose (such as sugar alcohols), have entered the market as dietetics.

Normally, the activation of the glucose transporters is mediated by the insulin signal. In diabetes mellitus type II, a dysfunctional signal transfer from the insulin receptor to the glucose transporter is found, which is ultimately accompanied by a more or less pronounced reduction in glucose uptake into the target cells. In extreme cases, the target cells become completely insensitive to insulin and the glucose level becomes uncontrollable. A major cause of insulin resistance is a decrease in the fluidity of the endothelial membranes of the blood vessels. Apart from other factors, an increased content of membrane-stabilizing cholesterol is responsible for the stiffening of the cell membranes in the vessels. The loss of fluidity causes the function of the insulin receptors and the glucose transporters to deteriorate, resulting in a glucose deficiency in the cells. This leads to the deterioration of physical performance and fatigue. Prolonged glucose deficiency can also trigger mitochondrial apoptosis in the brain and thus support the development of dementia. In its pathophysiological effects, diabetes mellitus type II is therefore to be understood as a glucose utilisation disorder.

Insulin resistance can occur at a young age as part of metabolic syndrome with a significant increase in the body mass index. The onset of diabetes is a direct consequence of the metabolic syndrome, which develops on the basis of a persistent oversupply of nutrients. Insulin, the release of which is induced by an elevated glucose level in the blood, is of particular importance. The membrane function of the peripheral blood vessels, which is impaired by the dysfunctional fat metabolism (caused by over-nutrition), impedes the function of the membrane-bound insulin receptors, which results in the glucose transporters not being expressed in a sufficient amount in the cell and not being made available at the cell membrane.

Since the transport of glucose into the brain is independent of insulin, an increase in the glucose uptake can hardly be achieved via the insulin system. The central glucose deficiency in the brain is due to an increasing dysfunction of the particularly dense blood-brain barrier at old age or the presence of a metabolic syndrome. This constant glucose deficiency in the brain also activates the food intake system. As a result of the poorly functioning saturation of the central glucose demand, an additional energy supply is constantly induced in the body, which additionally promotes weight gain.

In diabetes, the primary therapeutic goal is to normalize the glucose level in the blood. A number of successful drugs that effectively lower blood sugar levels by increasing insulin sensitivity are approved. In the interaction of the drug-activated insulin receptors with the expression and function of the glucose transporters, not only the glucose level in the blood is reduced. Above all, it ensures a sufficient supply of peripheral cells with one of the most important nutrients.

When it comes to diabetes therapy, state of the art pays little attention to the fact that the endothelial cells of the brain vessels that form the blood-brain barrier transport glucose constantly and largely independently of the insulin system. Hence, with sinking plasticity of the membranes also the brain suffers from an undersupply with glucose. However, in conventional diabetes therapy an existing glucose deficiency in the brain is not treated. The blood sugar level is lowered by activating the insulin receptors, which are hardly present at the blood-brain barrier. The removal of the blood sugar into the peripheral vessels can therefore even provoke an effect of “glucose stealing” and thus an increased undersupply of the brain.

Due to the central importance of glucose as an energy-supplying substrate on the one hand and as a metabolic building block on the other, its sufficient supply is physiologically dominantly regulated. Glucose deficiency in brain cells leads to intracellular metabolic reactions, which lead to the release of hormones and neurotransmitters. The feeling of hunger that develops in the course of these events and the subsequent processes that lead to food intake are fundamental and not yet fully understood. The neurotransmitter dopamine rewards food intake. Serotonin influences the nutrient uptake in the intestines and transmits that information to the central nervous system which, among other things, triggers satiation and satisfaction. The taste receptors on the tongue, in turn, influence the selection of the food ingested. In total, the feelings of hunger and satiation result in a very complex peripheral and central systemic event, which is primarily determined by the sufficient availability of glucose in the cells of the brain.

People can taste sweetness, sourness and saltiness because it helped our ancestors to find the right food. As a rule, what tastes sweet is rich in carbohydrates and thus provides a considerable amount of energy. It is also very likely that it is free of toxic substances. The pleasant taste is the reward for the intake of the most important food source. Starch is one of the three pillars of human nutrition and is nothing but polymeric glucose. It is produced as storage form of glucose in plants. In the course of digestion of starch-containing food, it is broken down in the body into glucose, which is absorbed. If starch-containing food remains in the mouth for a while, it begins to taste slightly sweet as glucose is enzymatically split off.

Glucose itself does not taste too sweet. This is probably the reason why “the energy source dextrose” has not become widely accepted as a sweetener. The sweetness of fructose or sucrose (cane sugar or beet sugar) is perceived much more intensively than the sweetness of glucose. At the molecular level, sucrose is composed of equal parts of glucose and fructose. Its sweetening power is significantly higher than that of glucose. Last but not least, sucrose has lately become a reference value in the evaluation of what is perceived as sweet. After all, there is a reason for why its sweetening power has received the reference value 1. Not least, human sensation is also based on it. Relative to the mass, only values between 0.5 to 0.8 of the sweetening power of sucrose are given for glucose.

The glucose demand in the brain increases both during intense physical and mental activity. Since only glucose is actively transported into the brain, while most of the fructose produced from sucrose in the same amount during digestion is metabolized in the liver and supplied to the peripheral metabolism, the satisfaction of the central glucose needs when eating sucrose is also connected to the provision of an equivalent amount of calories in the periphery, which does not directly contribute to the central energy need, but rather to weight gain. Since the sensation of sweetness and thus also the subjective reward effect following an intake of sucrose is “set”, an excessive intake of carbohydrates can also occur when eating dextrose instead of sucrose because it is less sweet.

The desire to eat sweets is part of a fundamental reward system in connection with food intake. The satiation and satisfaction generating effect explains the very high proportion of sugar in our diet. The craving for sweets varies interindividually and can be the trigger for bulimia. Overweight as a result of an unhealthy diet is the main cause of metabolic diseases, which in turn are the most common cause of death. A variety of diets, sweeteners, sugar substitutes and dietary supplements are believed to help. All these efforts almost always ignore the fact that the adequate supply of the brain is just as fundamental a prerequisite for life as the availability of oxygen. Without an adequate supply of glucose to the central nervous system, any attempt to lose weight is doomed to fail in the long run.

From the point of view of brain nutrition, the intake of sucrose inevitably leads to an excessive supply of carbohydrates. Dietary sugar substitutes of the carbohydrate type primarily provide energy for peripheral supply, but only indirectly contribute to the supply of glucose to the brain. With increasing insulin resistance, the glucose deficiency in the brain is even intensified by the intake of sugar substitutes or sweeteners during diets. In addition, sugar substitutes and calorie-free sweeteners massively disrupt the reward system which is based on taste perception.

For the reasons described above, people suffering from adult-onset diabetes or metabolic syndrome have an increased incidence of dementia in addition to a number of other side effects.

Mixtures of sugars with artificial sweeteners for the purpose of improving the taste of artificial sweeteners or mixtures in which sugar is used as a filler are the object of several patent applications. The aim of most of these applications is to reduce the amount of carbohydrates in dietetic products or to improve the taste by adding different sweeteners

### SUMMARY

The prior art does not take into account that a glucose deficiency in the brain practically reflexively leads to a craving for carbohydrates and that through such approaches the carbohydrate intake is actually increased rather than reduced.

The object of the invention is therefore to create first and foremost a preparation, in particular a dietetic preparation with which the intake of calories is reduced while retaining a sweetening power equalling that of sucrose.

At the same time, the invention relates to the use of a preparation according to the invention for efficiently supplying the brain with glucose while avoiding an increased carbohydrate supply to the peripheral blood stream of the body, in particular for the prophylaxis of dementia in humans and mammals.

According to the invention, the preparation is intended to prevent or alleviate a glucose deficiency in the brain of humans and other mammals. For this purpose, the preparation contains small amounts of a glucose-free sweetener, so that the portion of the preparation consisting of glucose and sweetener, i. e. in particular the sweetening portion, has a sweetening power corresponding to 1.5 to 3.0 times that of sucrose. Preferably, the sweetening power of the portion consisting of glucose and sweetener of the preparation according to the invention corresponds to a value of 2.0.

Fructose has the same molecular weight as glucose. In terms of immediate brain nutrition, this means that when sucrose is taken in, the same effect on brain metabolism and especially the brain's reward system is accompanied with twice the number of calories compared to pure glucose. In the composition according to the invention, the glucose contained in the mixture is adjusted to 1.5 to 3.0 times the sweetening power of sucrose by adding a defined amount of a sweetener. Thus, about 0.33 to 0.66 times, in particular half, of the amount by weight of a sweetened glucose produced in this way conveys the same sweetness as sucrose. Also, the taste signal produced correlates with that of sucrose, which provides the brain with the same amount of glucose.

A distinction can be made between the terms “sweetening power” and “sweetness”. While “sweetening power” can be a weight-independent value, “sweetness” can be related to a certain amount of sugar or sweetener. A certain sweetener can therefore always have the same sweetening power, while a food sweetened with this sweetener, for example, can have a different sweetness depending on the amount of sweetener it contains.

The administration of a preparation according to the invention quickly restores physical performance and, optionally, eliminates fatigue. The adequate supply of glucose to the brain also helps to prevent dementia. In overweight people, a welcome additional effect is that the same positive effect on human brain physiology is achieved by supplying only about 45% to 55% of the calories compared to sucrose, because the same sweetening effect is achieved with half the amount of carbohydrate.

A single sweetener or a mixture of several known sweeteners can be used as a sweetener, the aim being to achieve a taste as similar as possible to that of sucrose. Optionally, aspartame, alitame, acesulfame, a stevioside, saccharin, cyclamate, thaumatin, advantam, a suitable derivative of one of these substances or any mixture of two or more of these substances or suitable derivatives may be used as glucose-free sweetener. Mixtures according to the invention may have a very pleasant taste.

The preparation according to the invention may contain additives other than glucose and glucose-free sweetener.

Optionally, glycine can be added to the mixture to improve the taste.

The preparation according to the invention may be used in solid crystalline form or in liquid form as a sugar solution or syrup. Depending on the field of application, sweetened glucose may, for example also as a substitute for sucrose in dietetic food and luxury foodstuffs, be added to the preparation according to the invention, for example, as glucose syrup with a corresponding glucose content or in the course of sweetening food or sweet drinks, such as fruit juices, teas and milk drinks or in vitamin drinks and other functional drinks. The addition of colourings and flavourings to such drinks is customary and therefore covered by the application.

An optimized supply of glucose to the brain while avoiding an unnecessary intake of calories can optionally be achieved by administering the preparation according to the invention instead of sucrose.

The invention also provides a nutritional product. Accordingly, vitamins, preferably vitamins B9 and B12, and amino acids, preferably arginine, methionine and/or S-adenosylmethionine, can optionally be added to a preparation according to the invention.

The use of the glucose-sweetener mixtures according to the invention for brain nutrition is very efficient dietetically, but reaches its limits when there is an increase in the glucose level in the blood due to age or nutrition. A further increase in the blood sugar level due to glucose administration would promote the progression of a diabetic disease, which would not be helpful.

Since insulin resistance and thus an increase in blood sugar levels are closely related to a decrease in the fluidity of the vascular endothelium, the increase in blood sugar levels is also a signal for an inadequate supply of glucose to the brain. This deficiency can ultimately be remedied by measures to increase the transport of glucose across the blood-brain barrier.

Membrane transport can generally be increased by compounds that increase membrane fluidity. In order to improve the transport of glucose, the preparation according to the invention, in particular the nutritional product, may optionally contain a transport mediator. Optionally, this transport mediator can improve the transport of glucose into the brain.

In particular the glucose transporter GLUT1 is responsible for the transport of glucose across the blood-brain barrier. Therefore, the transport mediator may preferably be a preparation that activates the glucose transporter GLUT1. There are a number of state-of-the-art natural substances and drugs that are known to increase the transport activity of GLUT1. Especially AMP-activated protein kinase (AMPK) is a well-known pharmacological target. Particularly preferably, the transport mediator may therefore be an AMPK-activating agent or the transport mediator can act as an AMPK-activating agent.

In older people and in people with incipient insulin resistance, it is not only the restoration of physical performance and the elimination of fatigue that are the desired goals. Since all dementias are based on the destruction of neurons, regardless of their type, the apoptosis-inhibiting effect of glucose is of particular importance. The sufficient supply of energy to the aging brain can be massively supported by the preparation according to the invention as it supplies glucose. This fundamentally contributes to preventing dementia.

It is therefore another object of the invention to provide a preparation, in particular a dietetic preparation or a drug, which allows the treatment of glucose deficiency in the brain already at the onset of insulin resistance and is therefore particularly suitable for the prevention and reduction of dementia. A further object of the present invention is therefore to provide glucose-sweetener mixtures with an addition of transport activators and their use for brain nutrition or for the treatment or prophylaxis of a glucose deficiency in the brain of humans and other mammals, in particular for the treatment of dementia.

Optionally, a preparation according to the present invention comprises, in addition to glucose and a glucose-free sweetener, a transport mediator.

Phytopreparations may be used as transport mediators to increase the activity of the blood-brain barrier, especially those containing AMPK activators. Optionally, the phytopreparations can be prepared from the plant species Argemone mexicana, Berberis vulgaris, Coptis chinensis, Eschscholzia californica, Galega officinalis, Hydrastis Canadensis, Panax ginseng, Phellodendron amurense, Tinospora cordifolia or Xanthorhiza simplicissima. Such phytopreparations may be used in any form and in the nutritional product according to the invention, for example as extract or in the form of dried plant parts.

Preferred phytopreparations come from goat's rue (Galega officinalis; containing galegin) and barberry (Berberis vulgaris). Optionally, also tea mixtures from TCM (Traditional Chinese Medicine) can be used. These include ginseng (Panax ginseng) and other tea blends that are thought to have a memory-promoting or anti-demental effect.

Alternatively, the transport mediator can be an estrogen-like natural substance or an extract of such a natural substance. Preferred examples of this can be resveratrol, genistein and curcumin; however, these examples are not intended to limit the possible transport mediators from the family of estrogen-like natural substances. Any derivatives may optionally serve a comparable purpose as transport mediators.

Since omega-3 fatty acids unspecifically increase membrane fluidity, they may also be contained as transport mediator. In particular, an omega-3 fatty acid may be a fatty acid that is unsaturated at the omega-3 position. Fish oils containing omega-3 fatty acids are preferably used as emulsions, which may also improve the bioavailability of other water-insoluble transport mediators.

Optionally, a drug may also be used as a transport mediator. Preferred drugs according to the invention are biguanides, such as metformin, buformin or phenformin; however, the invention is not limited to this selection. Of course, other derivatives of these agents may also be effective as transport mediators. Due to its analogous structure, the amino acid arginine is also such a transport mediator.

The amount of the active ingredient in the combinations may be from 0.5% to 10% by weight of the total amount of the preparation. The exact amount depends on the desired effect and the respective transport mediator.

Optionally, it is provided that a preparation according to the invention contains several transport mediators.

These preparations according to the invention ensure a particularly efficient supply of glucose, which also delays incipient glucose intolerance in phases of an increase in the blood sugar level caused by the incipient loss of the plasticity of the vascular endothelium due to the increased glucose transport activity.

The invention also relates to the use of a preparation according to the invention for preparing a preparation to treat or prevent dementia in humans and mammals, while avoiding an increased carbohydrate supply to the peripheral bloodstream of the body.

Optionally, the preparation according to the invention may contain flavourings or other flavouring ingredients. This, for example, allows using it as tea or drink.

Optionally, the preparation according to the invention may be used to sweeten nutritional products, for example as a substitute for sucrose in yoghurts, beverages or other nutritional products.

Phytopreparations containing sweetened glucose may preferably be used in the amount that is used for the traditionally usual application. This mixing can be carried out in solid form or by adding glucose to a solution. For example, in the case of goat's rue, the herb/glucose ratio of the mixture is between 10:1 and 1:10.

In the case of liquid preparations, it is preferable to prepare a tea from 5 g to 20 g of the herb in 1 litre of water and to add 10 g to 200 g of sweetened glucose as well as vitamins and nutrients as supplements.

Further features of the invention become apparent from the exemplary embodiments and the patent claims.

In the following, the invention will be explained in detail by means of exemplary embodiments. The exemplary embodiments are not intended to restrict the scope of the invention, but merely to illustrate the invention and its effects.

### DETAILED DESCRIPTION

### Example 1: Sweetened Goat's-Rue Tea

700 mg of a cyclamate-saccharin mixture 10:1 is carefully mixed first with 50 g glucose and then with 60 g dried goat's-rue tea. From this a total of 2.5 litres of tea can be made. The sweetened solid tea-sugar mixture is divided into 10 portions and filled into tea bags. Each tea bag is infused with 250 ml of hot water and left to brew for 7 minutes.

According to the same method, also other sweetened tea blends can be made.

### Example 2: Sweetened Matcha Tea Powder and Tea

250 mg aspartame is carefully ground with 4 g matcha powder and 4 g glucose for 10 minutes. The trituration is carefully mixed with another 11 g of matcha powder and 36 g glucose for 10 minutes.

The mixture is infused with 1 to 1.5 litres of hot water according to taste, carefully stirred and optionally filtered. The solid mixture is packaged in 10 tea bags, from each of which 150 to 200 ml of tea are made.

Flavours, dried limes, orange or lemon peel, dried strawberry or raspberry pieces, ginger powder and the like can be added to improve or vary the taste.

### Example 3: Melissa Syrup with Sweetened Glucose

7.5 g stevioside, 900 g glucose and 100 g melissa leaves are suspended in 3 litres of water. To refine the taste, sliced lemons and/or orange slices can be added. The mixture is boiled for 3 minutes. Before cooling, 80 citric acid is stirred into the warm mixture. The covered receptacle is left to stand for 36 hours at 4 to 8° C., filtered through a filter cloth and bottled. The syrup is diluted with 5 to 10 parts of water before consumption. According to the same principle, also other syrups, such as peppermint or elderflower syrup, can be made.

### Example 4: Sweetened Glucose in a Vitamin Drink

360 mg aspartame and 60 g glucose are carefully mixed with 2 g arginine, 1.5 g methionine, 1 g glycine, 5 mg vitamin B6, 300 micrograms vitamin B9 (folic acid) and 4 micrograms vitamin B12 and packaged as 20 individual units. 1 sachet corresponds to the sweetening power of 2 teaspoons of sugar. The mixture can be used to sweeten tea, coffee and lemonades.

A mixture of 360 mg aspartame and 60 g glucose, 2 g arginine, 1.5 g methionine, 1 g glycine, 5 mg vitamin B6, 300 micrograms vitamin B9 (folic acid) and 4 micrograms vitamin B12 is dissolved in one litre of tea, water or juice. The amount produced is consumed as needed, preferably in portions throughout the day.

### Example 5: Sweetened Glucose in a Caffeine-Containing Drink

To 500 ml saturated soda water 0.5 g sodium carbonate, 420 mg of a cyclamate-saccharin mixture 10:1, 30 g glucose, 150 mg caffeine, 10 mg vitamin B6 and 10 micrograms vitamin B12, as well as flavouring substances and caramel color are added. The solution must be kept closed until use. The amount produced is consumed as needed, preferably in portions throughout the day.

### Example 6: Sweetened Glucose in a Cola Drink

In 1 litre of soda water 325 mg aspartame, 54 g glucose, 0.5 g sodium carbonate, 100 mg caffeine, 0.5 ml phosphoric acid E338, 1 g caramel color E150d and 0.05 g cola tincture are dissolved. The cola drink obtained must be kept closed.

### Example 7: Sweetened Glucose with Metformin

7 g fine crystalline aspartame is carefully ground with 70 g fine crystalline glucose and 20 g metformin hydrochloride for 10 minutes. Then the trituration is carefully mixed with 930 g glucose for 10 minutes. The sweetening power of the mixture corresponds to that of about 2 kg or 500 teaspoons of sucrose. The mixture is either filled into sachets, pressed into cubes or packaged as a loose mixture.

### Example 8: Sweetened Glucose in a Drink Containing Metformin

360 mg aspartame and 60 g glucose are dissolved in 1 litre of water (tea). 2 g metformin, 1 g glycine, 1 g adenosylmethionine, 5 mg vitamin B6, 300 micrograms vitamin B9 (folic acid) and 4 micrograms vitamin B12 are added to this solution. The amount produced is consumed as needed, preferably in portions throughout the day.

### Example 9: Sweetened Longjing Tea

8 g Jing tea mixture is carefully ground with 125 mg aspartame and 20 g glucose. The dry mixture is divided into 4 portions and filled into tea bags, from each of which 125 ml of sweetened tea can be made by infusing with hot water.

The mixture is infused with 0.5 litres of hot water, carefully stirred and filtered through a tea filter.

According to the recipe of this example further teas of TCM can be prepared.

### Example 10: Sweetened Ginseng Tea

30 g ginseng root granules is carefully ground with 1 g of a cyclamate-saccharine mixture 10:1, and 75 g glucose. The dry mixture is divided into 10 portions and filled into tea bags, from each of which 125 ml of sweetened tea can be made by infusing with hot water.

The mixture is infused with 1.25 litres of hot water, carefully stirred, left to brew and filtered through a tea filter.

### Example 11: Sweetened Glucose with Curcumin Omega-3 Fish Oil

1 g curcumin (curcuma extract), 10 mg piperine and 0.5 g soy lecithin are carefully mixed with 2 g omega-3 fish oil. 90 mg aspartame and 15 g glucose are dissolved in 250 ml water. The oily and aqueous components are shaken to form an emulsion, wherein the aqueous phase is added in portions. The product must be kept closed. The amount produced is consumed as needed, preferably in portions throughout the day.

### Example 12: Sweetened Glucose with Genistein in Omega-3 Fish Oil

300 mg soya extract with a minimum content of 30 mg isoflavones and 0.1 g soya lecithin are mixed into 2 g omega-3 fish oil. 1.5 g aspartame, 2.5 g glycine and 15 g glucose are dissolved in 250 ml water. The oily and aqueous components are shaken to form an emulsion, wherein the aqueous phase is added in portions. The product must be kept closed. The amount produced is consumed as needed, preferably in portions throughout the day.

### Example 13: Sweetened Glucose with Resveratrol in Omega-3 Fish Oil

10 mg pure resveratrol and 0.5 g soy lecithin are mixed into 2 g omega-3 fish oil. 210 mg of a cyclamate-saccharin mixture 10:1 and 15 g glucose are dissolved in 250 ml water and 1 g glycine, 1 g adenosylmethionine, 5 mg vitamin B6, 300 micrograms vitamin B9 (folic acid) and 4 micrograms vitamin B12 are added. The oily and aqueous components are shaken to form an emulsion, wherein the aqueous phase is added in portions. The product must be kept closed. The amount produced is consumed as needed, preferably in portions throughout the day.

### Example 14: Sweetened Glucose Through Blending

7 g fine crystalline aspartame is carefully ground with 70 g fine crystalline glucose for 10 minutes. Then the trituration is carefully mixed with 930 g glucose for 10 minutes. The mixture is ready for use and can be filled into 200 sachets as single portions.

### Example 15: Sweetened Glucose Through Co-Crystallization

While stirring, 950 g glucose is added in portions to a solution of 50 g cyclamate in 500 ml distilled water. The semi-solid suspension is stirred for 30 minutes and then the water is distilled off in a vacuum at a temperature of less than 40° C. The product obtained is dried in a vacuum at 40° C. for 12 hours.

### Example 16: Sweetened Glucose Through Co-Crystallization

5 g saccharin and 995 g glucose are almost completely dissolved at 30° C. in 1.5 litres of water. The solution is evaporated in a vacuum at 40° C. The solid product obtained is dried in a vacuum at 40° C. for 16 hours, then ground and sieved.

### Example 17: Sweetened Glucose Refined with Glycine

6 g crystalline aspartame, 10 g crystalline glycine and 60 g glucose are carefully ground for 10 minutes. Then the trituration is carefully mixed with 930 g glucose for 10 minutes. The mixture is ready to use.

1-23. (canceled)

24. A dietetic preparation for preventing or alleviating a glucose deficiency in the brain of humans or mammals, characterized in that the preparation contains glucose and at least one glucose-free sweetener, wherein the mixture of glucose and glucose-free sweetener has a sweetening power of 1.5 to 3.0, in particular 2.0.

25. The dietetic preparation according to claim 24, characterized in that the calorific value of the mixture of glucose and glucose-free sweetener corresponds to 45% to 55% of the calorific value of an amount of sucrose with the same sweetness.

26. The dietetic preparation according to claim 24, characterized in that the preparation contains aspartame, alitame, acesulfame, a stevioside, saccharin, cyclamate, thaumatin, advantam, a suitable derivative of one of these substances, or any mixture of two or more of these substances or suitable derivatives as glucose-free sweetener.

27. The dietetic preparation according to claim 24, characterized in that the preparation contains glycine.

28. The dietetic preparation according to claim 24, characterized in that the preparation contains glucose in the form of glucose syrup.

29. The dietetic preparation according to claim 24, characterized in that the preparation contains glucose in solid crystalline or granular form.

30. The preparation according to claim 24, characterized in that the preparation comprises a transport mediator, wherein the transport mediator is an agent which improves the transport of glucose into the brain and wherein the transport mediator is in particular selected from the group of biguanides, in particular metformin, buformin or phenformin or a derivative of these substances,
the group of estrogen-like natural substances, in particular resveratrol, genistein and curcumin or a derivative of these substances,
the group of phytopreparations, in particular phytopreparations from the plant species Argemone mexicana, Berberis vulgaris, Coptis chinensis, Eschscholzia californica, Galega officinalis, Hydrastis Canadensis, Panax ginseng, Phellodendron amurense, Tinospora cordifolia or Xanthorhiza simplicissima, or
the group of omega-3 fatty acids.

31. The preparation according to claim 30, characterized in that the transport mediator is an agent that activates the glucose transporter GLUT1, preferably an AMPK-activating agent.

32. The preparation according to claim 30, characterized in that the transport mediator is an agent from the group of biguanides.

33. The preparation according to claim 32, characterized in that the transport mediator is metformin, buformin or phenformin or a derivative of these substances.

34. The dietetic preparation according to claim 30, characterized in that the transport mediator is an estrogen-like natural substance.

35. The dietetic preparation according to claim 34, characterized in that the transport mediator is resveratrol, genistein and curcumin or a derivative of these substances.

36. The dietetic preparation according to claim 31, characterized in that the transport mediator is an AMPK-activating phytopreparation.

37. The dietetic preparation according to claim 36, characterized in that the phytopreparation is made of Panax ginseng.

38. The dietetic preparation according to claim 36, characterized in that the phytopreparation is prepared from the plant species Argemone mexicana, Berberis vulgaris, Coptis chinensis, Eschscholzia californica, Galega officinalis, Hydrastis Canadensis, Panax ginseng, Phellodendron amurense, Tinospora cordifolia or Xanthorhiza simplicissima.

39. The dietetic preparation according to claim 30, characterized in that the transport mediator is an omega-3 fatty acid.

40. The dietetic preparation according to claim 30, characterized in that between 0.5% by weight and 10% by weight of the transport mediator are contained in relation the total weight of the preparation.

41. The dietetic preparation according to claim 24, characterized in that the preparation contains a vitamin, preferably vitamin B9 and/or vitamin B12.

42. The dietetic preparation according to claim 24, characterized in that the preparation contains methionine, arginine and/or S-adenosylmethionine.

43. The dietetic preparation according to claim 24, characterized in that the preparation contains flavourings or other flavouring ingredients.

44. Treating or preventing dementia in humans and mammals, while avoiding an increased carbohydrate level in the peripheral bloodstream of the body by using a preparation according to claim 24.

45. Sweetening a nutritional product by using a preparation according to claim 24.
